(19) United States
(12) Patent Application Publication
(10) Pub. No.: US 2014/0089921 A1
(43) Pub. Date: Mar. 27, 2014

(54) METHOD AND SYSTEM FOR MANAGING VIRTUAL MACHINE DISKS

(71) Applicant: EMC Corporation, Hopkinton, MA (US)

(72) Inventors: Ziye Yang, Shanghai (CN); Haifeng Fang, Beijing (CN); Chenhui Thomas Fan, Shanghai (CN); Roby Qiyan Chen, Shanghai (CN)

(21) Appl. No.: 13/930,104

(22) Filed: Jun. 28, 2013

(30) Foreign Application Priority Data
Sep. 27, 2012 (CN) CN201210375612.X

(51) Int. Cl. G06F 9/455

(52) U.S. Cl. CPC G06F 9/45533
USPC 718/1

(57) ABSTRACT

Embodiments of the present invention relate to a method and system for managing a virtual machine disk. According to embodiments of the present invention, thin provisioning and thick provisioning are integrated to form a hybrid virtual machine disk management mechanism. Specifically, for a thin provisioned VM disk, if it is determined that the load level of the disk is relatively high, it may be decided to switch the VM disk to be thick provisioned. On the contrary, for a thick provisioned VM disk, if it is determined that a load level of the disk is relatively low, it may be decided to switch the VM disk to be thin provisioned so as to avoid resource waste. In this way, the efficiency and flexibility of the management of virtual machine storage disks may be improved.

### FIELD OF THE INVENTION

Embodiments of the present invention generally relate to virtual machines, and more specifically to a method and system for managing virtual machine disks.

### BACKGROUND OF THE INVENTION

Virtual machine (VM) refers to an application execution environment created by a particular application on a hardware platform of a physical machine, through which environment a user may run applications and interact therewith, just like using a physical machine. When creating a virtual machine, it is generally required to allocate, from a storage pool in a host machine system that hosts the virtual machine, a certain amount of storage resources available for use by the virtual machine. The allocated storage resources form a virtual machine disk (VM disk). Allocation and management of the virtual machine disk are important for the performance of the virtual machine. Generally speaking, management mechanisms for a virtual machine disk may be divided into thick provisioning and thin provisioning, as known in the art.

Thick provisioning means allocating all the storage resources required by a virtual machine disk from a storage pool upon creation of the virtual machine. This allocation approach is simple and direct, and the management of the virtual machine disk at runtime is relatively simple. However, it is clear that the thick provisioning might cause potential waste of storage resources. A virtual machine might only use a small part of all the allocated disk resources, and the idle storage resources cannot be utilized by other virtual machines. Although this problem can be alleviated by using a solution such as disk shrinking, the thick provisioning would still cause considerable resource waste in many scenarios.

In contrast, the thin provisioning does not allocate all storage resources required by a virtual machine disk upon creation of the virtual machine. Instead, resources are dynamically allocated and recycled on demand during the execution of the virtual machine. The thin provisioning can reduce storage occupation costs and virtual machine storage migration time, and can also improve the resource utilization of the virtualization system. However, thin provisioning also has some problems and defects. First, the thin provisioning has a problem of increasing metadata costs. Metadata is the data used to management those allocated disk blocks. With more disk blocks being allocated, the amount of metadata will constantly increase. Further, it is also necessary to frequently update the metadata. One of serious problems that may be caused by frequent metadata access is the lock contention, which must be solved by making change at the level of hardware. Second, when a system has multiple thin provisioned virtual machine disks, dynamic disk space allocation and recycling would cause more and more fragmentations in the storage pool. Therefore, it is necessary to regularly manage the fragmentations in the storage pool to make the storage resources as continuous as possible, which increases burdens of managing the virtual machine storage. Further, there is no efficient disk block recycling mechanism for a thin provisioned virtual machine disk.

Therefore, there is a need in the art for a more efficient solution of managing virtual machine disks.

### SUMMARY OF THE INVENTION

In view of the above problems existing in the prior art, the present invention provides a method and system for managing a virtual machine disk.

According to one aspect of the present invention, there is provided a method of managing a virtual machine disk. The method comprises: determining whether the virtual machine disk is thin provisioned or thick provisioned; monitoring use information for the virtual machine disk based on the determining to obtain a load level of the virtual machine disk; and deciding whether to switch the virtual machine disk between the thin provisioning and the thick provisioning based on the load level.

According to another aspect of the present invention, there is provided a method of managing a virtual machine disk. The system comprises: a determining module configured to determine whether the virtual machine disk is thin provisioned or thick provisioned; a monitoring module configured to monitor use information for the virtual machine disk based on the determining to obtain a load level of the virtual machine disk; and a decision module configured to decide whether to switch the virtual machine disk between the thin provisioning and the thick provisioning based on the load level.

According to embodiments of the present invention, the thin provisioning and thick provisioning are integrated to form a hybrid virtual machine disk management mechanism. Specifically, for a thin provisioned virtual machine disk, if it is determined that a load level of the virtual machine disk is relatively high, the VM disk may be switched to be thick provisioned. On the contrary, for a thick provisioned virtual machine disk, if it is determined that a load level of the virtual machine is relatively low, then the VM disk may be switched to be thin provisioned to avoid resource waste. In this way, it is possible to fully take advantages of both the thin and thick provisioning to thereby improve the efficiency and flexibility of the management of virtual machine disks.

### BRIEF DESCRIPTION OF THE DRAWINGS

Through reading the following detailed description with reference to the accompanying drawings, the above and other objectives, features and advantages of embodiments of the present invention will become more comprehensible. In the drawings, several embodiments of the present invention will be illustrated in an exemplary and non-limiting manner, wherein:

FIG. 1 shows a flowchart of a method 100 for managing a virtual machine disk according to exemplary embodiments of the present invention;

FIG. 2 shows a flowchart of a method 200 for managing a thin provisioned virtual machine disk according to exemplary embodiments of the present invention;

FIG. 3 shows a flowchart of a method 300 for managing a thick provisioned virtual machine disk according to exemplary embodiments of the present invention;

FIG. 4 shows a block diagram of a system 400 for managing a virtual machine disk according to exemplary embodiments of the present invention; and

FIG. 5 shows a block diagram of a computer system 500 which is applicable to implement embodiments of the present invention.

Throughout the drawings, same or similar reference symbols refer to same or similar parts.

### DETAILED DESCRIPTION OF EMBODIMENTS

Principle and spirit of the present invention will now be described with reference to various exemplary embodiments illustrated in the drawings. It should be understood that these embodiments are provided only to enable those skilled in the art to better understand and further implement the present invention, not intended for limiting the scope of the present invention in any manner.

Generally, the inventive idea of the present invention lies in forming a hybrid virtual machine disk management mechanism by integrating the thin provisioning and thick provisioning. Specifically, for a thin provisioned virtual machine disk, if it is determined that a current load level of the virtual machine is relatively high, it is possible to decide to switch the VM disk to be thick provisioned. On the contrary, for a thick provisioned virtual machine disk, if it is determined that a current load level of the virtual machine disk is relatively low and there is a storage resource waste, it is possible decide to switch the VM disk to be thin provisioned. In this way, embodiments of the present invention may take advantages of both the thin provisioning and thick provisioning, thereby improving the efficiency and flexibility of management of virtual machine storage disks.

In the following description, a virtual machine is described to be created and executed on a physical machine. The system hosting a virtual machine is called a host or a host system. The host system may allocate storage resources from a storage pool to one or more virtual machine disks, and the host system may also recycle the storage resources allocated to the virtual machine disk into the storage pool. Further, although the storage space is sometimes called “disk” in the following, it is merely for the purpose of clarity and should not be constructed as limit of the present invention. On the contrary, the virtual machine disk management mechanism proposed in the present invention may be applicable to various kinds of storage mediums and mechanisms.

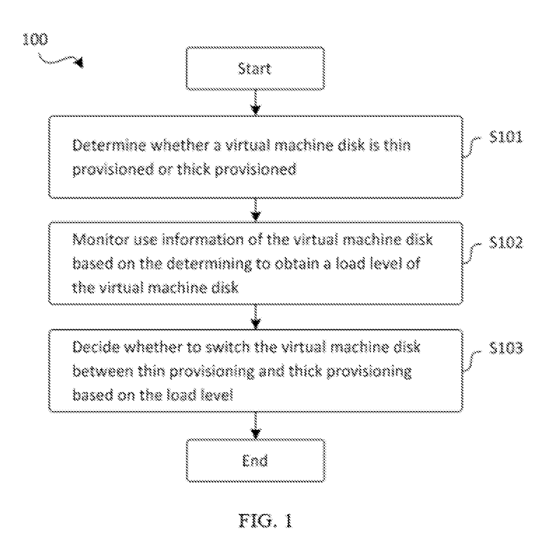

With reference to FIG. 1, it shows a flowchart of a method 100 for managing a virtual machine disk according to exemplary embodiments of the present invention. According to embodiments of the present invention, the instance of the method 100 may be executed by a host system hosting the virtual machine.

After method 100 starts, at step S101, it is determined whether the virtual machine disk is thin provisioned or thick provisioned.

As described above, the thin provisioning means that only a part not all of the required storage resources are allocated to a virtual machine disk upon creation of the virtual machine, and the storage resources in the virtual machine disk are dynamically allocated and recycled at runtime. Specifically, during the execution of the virtual machine, the host system may dynamically allocate additional storage space from the storage pool to the virtual machine disk based on the request from the virtual machine. On the contrary, the thick provisioning means that all the required storage resources required by the virtual machine disk are allocated to the VM disk when creating the virtual machine.

Those skilled in the art would appreciate that the provisioning mechanism of the virtual machine disk may be determined by a host system of the virtual machine. Therefore, for any virtual machine disk, the host system may determine whether the virtual machine disk is thin provisioned or thick provisioned. For example, the host system may record the provisioning mechanism of each virtual machine disk that it hosts. These records, for example, may be saved in various manners such as a provisioning file, a profile, a registry entry, a table, or mapping. The scope of the present invention is not limited in this regard. Accordingly, at step S101, the provisioning mechanism of any virtual machine disk may be determined by accessing such record.

Next, the method proceeds to step S102, where the use information of the virtual machine disk is monitored based on the determining at step S101 to obtain a load level of the virtual machine disk. Those skilled in the art would appreciate that for different provisioning mechanisms, different data and information that measures the operation condition or the load level of the virtual machine disk may be monitored as the use information. The term “load level” as used herein refers to the busy degree of the virtual machine disk or the heavy degree of the work load. In the context of the present application, the load level may include a utilization of the virtual machine disk and a performance level of the virtual machine disk, which will be detailed hereinafter.

Specifically, according to some embodiments of the present invention, if it is determined at step S101 that the virtual machine disk is thin provisioned, then the use information as monitored at step S102 may include one or more of the following: capacity of allocated disk blocks, amount of metadata for managing the allocated disk blocks, input/output per second (IOPS) of the virtual machine disk, throughput of the virtual machine disk, delay response of the virtual machine disk, and the like.

Likewise, if it is determined at step S101 that the virtual machine disk is thick provisioned, then the use information as monitored at step S102 at least may comprise one or more of the following: currently used capacity of the virtual machine disk, IOPS, throughput of the virtual machine disk, delay response of the virtual machine disk, etc. Specifically, compared with the thin provisioning, the use information monitored for a thick provisioned virtual machine disk does not include the amount of metadata for managing allocated disk blocks, because a thick provisioned virtual machine disk does not need such metadata to operate.

It should be noted that what have been described are merely several examples of use information of a virtual machine disk. Those skilled in the art would envisage monitoring alternative and/or additional information to measure the load level of a thin or thick provisioned virtual machine disk. All such information can be used as the “use information” in connection with embodiments of the present invention.

Further, it should be noted that the monitoring of the use information at step S102 may be performed continuously (for example, in background). Alternatively or additionally, the use information of the virtual machine disk may be monitored periodically with a certain time interval.

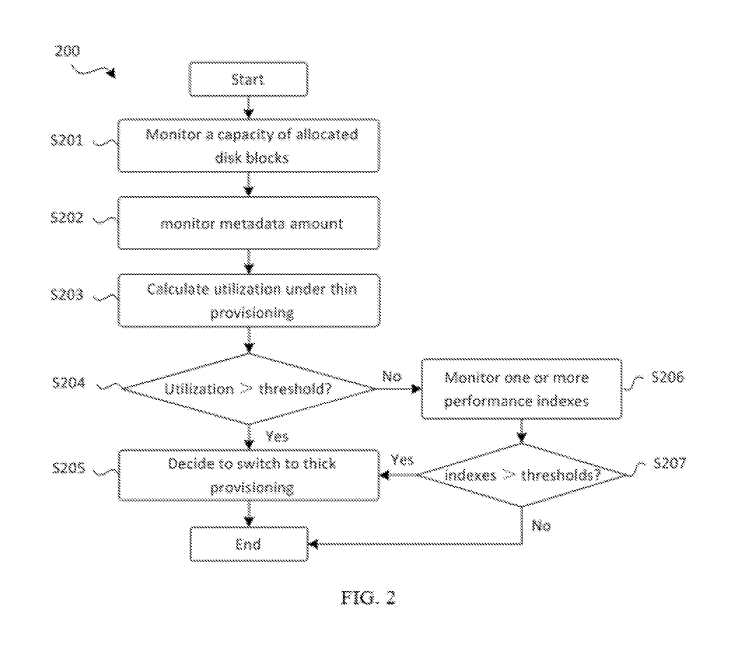

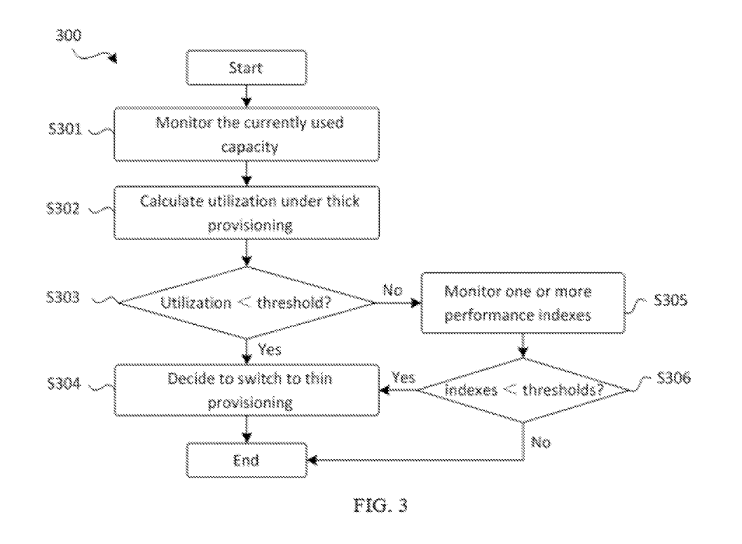

It would be appreciated that some use information monitored at step S102 may directly reflect the load level of the virtual machine disk, for example, the IOPS, throughput, delay response of the virtual machine disk and the like. On the other hand, it is necessary to perform computation or operation on other monitored use information to indicate the load level of the virtual machine disk. For example, if the virtual machine disk is thin provisioned, the load level may include a utilization of the thin provisioned virtual machine disk, and such utilization may be calculated based on the capacity of allocated disk blocks and the amount of metadata as monitored in at step S102 as well as the total capacity of the virtual machine disk. Likewise, if the virtual machine disk is thick provisioned, the load level may comprise the utilization of the thick provisioned virtual machine disk which may be calculated based on the total capacity of the virtual machine disk and the currently used capacity. The detailed example in this regard will be further described with reference to FIGS. 2 and 3.

Next, the method 100 proceeds to step S103, where it is determined whether to switch the virtual machine disk between the thin provisioning and the thick provisioning based on the load level determined at step S102.

According to embodiments of the present invention, if the virtual machine disk is currently thin provisioned and its load level has exceeded a predetermined threshold, it may be determined to switch the virtual machine disk from the thin provisioning to the thick provisioning. In this way, it is possible to deal with the growth of the metadata amount caused by the increase of allocated disk blocks. Moreover, the virtual machine disk may be used transparently in other virtualization platforms.

On the other hand, if the virtual machine disk is currently thick provisioned and its load level is below the predetermined threshold, it may be determined to switch the virtual machine disk from thick provisioning to thin provisioning. In this way, the storage resources in the storage pool can be effectively utilized to avoid resource waste caused by long-term idleness of the disk.

The method 100 ends after step S103. By use of the method 100, the use condition of the virtual machine disk can be dynamically monitored during the operation of the virtual machine, and decision may be made whether to change the provisioning pattern of the virtual machine disk.

Reference is now made to FIG. 2, a flowchart of a method 200 for managing a thin provisioned virtual machine disk according to exemplary embodiments of the present invention is shown. It would be appreciated that the method 200 is a specification implementation of the method 100 described above when the virtual machine disk is determined as being thin provisioned.

After the method 200 starts, at step S201, a capacity of allocated disk blocks that are already allocated to the virtual machine disk is monitored. For example, according to some embodiments, the number of disk blocks allocated to the virtual machine disk in execution may be obtained, for example, from a host system hosting the virtual machine. Additionally, the size of each allocated disk block may also be known. For example, the size of the allocated disk blocks may be a known constant or variant, for example, 1M, 2M, 4M, etc. By accessing the number and size of allocated disk blocks from the host system, the capacity of the allocated disk blocks may be determined

Next, the method 200 proceeds to step S202, where the amount of metadata for managing the allocated disk blocks is monitored. As above mentioned, for a thin provisioned virtual machine disk, the metadata is used for managing allocated disk blocks. For example, the metadata may be used to manage a mapping between a guest storage address interval (GSAI) and a host storage address interval (HSAI). With the increase of the number of allocated disk blocks, the metadata amount will increase as well. Those skilled in the art would appreciate that the amount of metadata for each allocated disk block is known to the host system. Therefore, the metadata amount for the virtual machine disk may be obtained based on the number of allocated disk blocks and the amount of metadata for each allocated disk block.

The method 200 then proceeds to step S203, where the utilization of the thin provisioned virtual machine disk is calculated based on the capacity of allocated disk blocks as monitored at step S201, the metadata amount as monitored at step S202, and the total capacity of the virtual machine disk as follows:

Utilization for a thin provisioned disk=(Capacity of the allocated disk blocks+Metadata amount)/Total capacity of the disk

wherein the total capacity of the virtual machine disk is generally known or pre-determined For example, when creating a virtual machine on a host system, the virtual machine may request and indicate the capacity of the virtual machine disk to the host system. Alternatively or additionally, the total capacity of the virtual machine disk may also be specified by the host system.

At step S204, the utilization of the thin provisioned virtual machine disk is compared with a predetermined threshold (for example, 80%, or any other numerical value) to determine whether the utilization of the virtual machine disk exceeds the predetermined threshold. If the utilization of the virtual machine disk exceeds the predetermined threshold (branch “yes”), the method 200 proceeds to step S205 where it is decided to switch the virtual machine disk to be thick provisioned.

If it is determined at step S204 that the utilization of the thin provisioned disk is lower than the predetermined threshold (branch “No”), the method 200 proceeds to step S206 where one or more performance indexes indicating the performance level of the virtual machine disk can be monitored, the performance indexes including but not limited to one or more of the following: how many times of I/O event occurs on the virtual machine disk in average per second, i.e., IOPS; throughput of the virtual machine disk; response delay of the virtual machine disk, etc. These performance indexes are compared with corresponding one or more predetermined thresholds at step S207. If it is determined that one or more of the performance indexes have exceeded the corresponding thresholds (branch “yes”), the method 200 proceeds to step S205 where it is decided to switch the virtual machine disk to be thick provisioned.

The method 200 ends after step S205. It should be noted that the “end” here is only logical, and the method 200 may be executed periodically or repeatedly to continuously monitor the utilization situation of the virtual machine disk.

It should be understood that the above described sequence of method steps is just exemplary. For example, although the embodiment in FIG. 2 is described to initially calculate the utilization of the thin provisioned virtual machine disk (through step S201 to S203) and then to monitor the performance indexes (through step S206 to S207), it is only for the sake of clarity of the description. In fact, these two kinds of use information may be monitored in any sequence or in parallel. Further, the method 200 may monitor either the disk utilization or the one or more performance indexes, instead of necessarily both of them. Moreover, the above mentioned IOPS, throughput, and response delay are merely several examples of performance indexes, and the method 200 may also monitor any other necessary or appropriate data or indexes. The scope of the present invention is not limited in these regards.

Referring to FIG. 3, a flowchart of a method 300 for managing a thick provisioned virtual machine disk according to exemplary embodiments of the present invention is shown. It would be appreciated that the method 300 is a specific implementation of the method 100 described above when the virtual machine disk is determined as being thick provisioned.

After method 300 starts, at step S301, a currently used capacity of the virtual machine disk is monitored. For example, according to some embodiments, the number of disk blocks currently in use on the virtual machine disk may be determined, which number is recorded by the host system. In the meantime, the size of each disk block currently in use is also known, for example, by the host system. Therefore, the currently used capacity of the virtual machine disk can be calculated.

Next, the method 300 proceeds to step S302 where the utilization of the thick provisioned virtual machine disk is calculated based on the currently used capacity of the virtual machine disk as monitored at step S301 and the total capacity of the virtual machine disk (the total capacity is generally known or determined in advance):

Utilization of the thick provisioned disk=Used capacity/Total capacity of the disk

It should be noted that different from the thin provisioning, the thick provisioning does not need metadata to manage allocated disk blocks because all disk resources have been allocated at a time when the virtual machine is created. Thus, as long as the currently used capacity of the virtual machine disk is monitored, the utilization of the thick provisioned virtual machine disk can be calculated.

Next, the method 300 proceeds to step S303 where the calculated utilization of the thick provisioned virtual machine disk is compared with the predetermined threshold (for example, 20%, or any other numerical value) to determine whether the utilization for the thick provisioned disk is lower than the predetermined threshold. If the utilization under thick provisioning is below the predetermined threshold (branch “Yes”), the method 300 proceeds to step S304 to decide to switch the virtual machine disk to be thin provisioned.

If it is determined at step S303 that the utilization under thick provisioning is higher than the predetermined threshold (branch “No”), the method 300 proceeds to step S305 where one or more performance indexes indicating the performance level of the virtual machine disk can be monitored, the performance indexes including but not limited to one or more of the following: how many times of I/O event occurs on the virtual machine disk in average per second, i.e., IOPS; throughput of the virtual machine disk; response delay of the virtual machine disk, and the like. These performance indexes are compared with corresponding one or more predetermined thresholds at step S306. If it is determined that one or more of the performance indexes are lower than the corresponding thresholds (branch “yes”), the method 300 proceeds to step S304 where it is decided to switch the virtual machine disk to be thin provisioned.

The method 300 ends after step S304. It should be noted that the “end” here is only logical, and the method 300 may be executed periodically or repeatedly to continuously monitor the utilization situation of the virtual machine disk.

It should be understood that the above described sequence of method steps is only exemplary. For example, although the embodiment in FIG. 3 is described to initially calculate the utilization of the thick provisioned virtual machine disk (through step S301 to S303) and then to monitor the performance indexes (through step S305 to S306), it is only for the sake of clarity of the description. In fact, these two kinds of use information may be monitored in any sequence or in parallel. Further, the method 300 may monitor either the disk utilization or one or more performance indexes instead of necessarily both of them. Moreover, the above mentioned IOPS, throughput, and response delay are merely several examples of performance indexes, and the method 300 may also monitor any other necessary or appropriate data or indexes. The scope of the present invention is not limited in these regards.

A hybrid virtual machine disk management solution according to the present invention has been described. It would be appreciated that the core idea of the present invention lies in dynamically determining whether to switch the VM disk between thin provisioning and thick provisioning based on the actual use condition of the virtual machine disk.

If it is decided to switch the disk provisioning, embodiments of the present invention may perform switching in any suitable manner. For example, according to some embodiments, the switching may be performed offline. In other words, the virtual machine is first set into an inactive state, then the switching of provisioning pattern is performed, and finally the virtual machine is re-activated. Alternatively, according to other embodiments, the switching may also be performed online mode, i.e., the provisioning manner of the virtual machine disk is changed while the virtual machine keeps running To this end, any suitable technical means, no matter currently known or developed in the future, may be used in connection with embodiments of the present invention. These mechanisms may include but not limited to snapshot policy, dirty block tracking, I/O monitoring and tracking, and the like. The scope of the present invention is not limited in this regard.

It should be noted that the main problem solved by the present invention is how to dynamically judge or decide whether to switch a virtual machine disk between the thin provisioning and the thick provisioning. The switching per se of the virtual machine disk is not a focus of the present invention. Any currently known or future developed virtual machine disk switching mechanism can be used in connection with embodiments of the present invention.

Additionally, according to some embodiments of the present invention, in order to further improve the storage management of the virtual machine, the utilization of the storage pool may also be monitored. For example, the host system may periodically or continuously calculate the ratio between the allocated storage resources and the total capacity of the pool. Once it is determined that the utilization exceeds the predetermined threshold, new storage resources will be added into the storage pool of the system for allocation to the virtual machine disk. Alternatively or additionally, the user may also be altered when the utilization of the storage pool exceeds a predetermined threshold.

In some other embodiments of the present invention, the resource fragment condition in the storage pool of the host system may also be monitored periodically. Once it is found that too many resource fragments appear in the storage pool, or in response to an indication from the user, a process such as resource defragmenting may be carried out. Any currently known or future developed storage resource defragmentation mechanism may be used in connection with embodiments of the present invention, and the scope of the present invention is not limited in this regard.

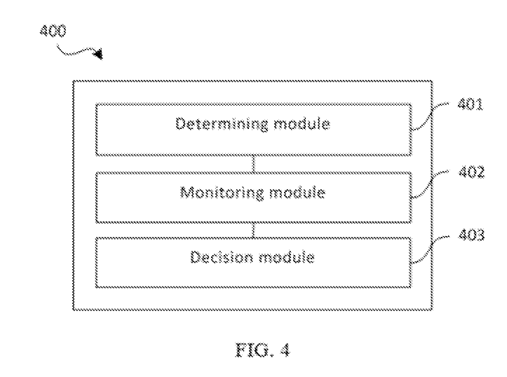

With reference to FIG. 4, it shows a block diagram of a system 400 for managing a virtual machine disk according to exemplary embodiments of the present invention. As shown in the figure, according to embodiments of the present invention, the system 400 comprises: a determining module 401 configured to determine whether the virtual machine disk is thin provisioned or thick provisioned; a monitoring module 402 configured to monitor use information for the virtual machine disk based on the determining to obtain a load level of the virtual machine disk; and a decision module 403 configured to decide whether to switch the virtual machine disk between the thin provisioning and the thick provisioning based on the load level.

According to some embodiments, the monitoring module 402 may comprise: a thin monitoring module configured to monitor the capacity of the allocated disk blocks and an amount of metadata for managing the allocated disk blocks in response to determining that the virtual machine is thin provisioned; and a thin disk utilization calculating module configured to calculate a utilization of the thin provisioned virtual machine disk based on the capacity of the allocated disk blocks, the amount of metadata, and a total capacity of the virtual machine disk.

According to some embodiments, the monitoring module 402 may comprise: a thick monitoring module configured to monitor a used capacity of the virtual machine disk in response to determining that the virtual machine is thick provisioned; and a thick disk utilization calculating module configured to calculate a utilization of the thick provisioned virtual machine disk based on the used capacity and the total capacity of the virtual machine disk.

According to some embodiments, the monitoring module 402 at least may comprise one or more of the following: an IOPS monitoring module configured to monitor input/output per second (IOPS) of the virtual machine disk; a throughput monitoring module configured to monitor a throughput of the virtual machine disk; and a delay monitoring module configured to monitor a response delay of the virtual machine disk.

According to some embodiments, the decision module 403 may comprise: a thin-to-thick switching decision module configured to decide, in response to determining that the virtual machine is thin provisioned, to switch the virtual machine disk to be thick provisioned when the load level exceeds a predetermined threshold.

According to some embodiments, the decision module 403 may comprise: a thick-to-thin switching decision module configured to decide, in response to determining that the virtual machine is thick provisioned, to switch the virtual machine disk to be thin provisioned when the load level is lower than a predetermined threshold.

According to some embodiments, the system 400 further comprises: a switching module configured to perform the switching in response to the decision to switch the virtual machine disk between the thin provisioning and the thick provisioning.

According to some embodiments, the storage resources of the virtual machine disk are allocated from the storage pool by the host system hosting the virtual machine, and the system 400 further comprises: a storage pool utilization monitoring module configured to monitor a utilization of the storage pool; and a resource adding module configured to add storage resources into the storage pool for allocation to the virtual machine disk in response to the utilization of the storage pool exceeding the predetermined threshold.

According to some embodiments, the storage resources of the virtual machine disk are allocated from the storage pool by the host system hosting the virtual machine, and the system 400 further comprises: a fragmentation monitoring module configured to monitor a condition of storage resource fragmentations of the storage pool; and a defragmenting module configured to defragment the storage resource in the storage pool.

It should be noted that for the sake of clarity, alternative modules and modules comprised in respective modules are not illustrated in FIG. 4. However, it should be understood that respective modules comprised in system 400 correspond to respective method steps as above described with reference to FIGS. 1-3. Therefore, all the features as above described with reference to FIGS. 1-3 are applicable to the system 400, which will not be detailed here.

It should be understood that the system 400 may be implemented in various manners. For example, in some embodiments, the system 400 may be implemented using software and/or firmware modules. Alternatively or additionally, the system 400 may be implemented partially or completely based on hardware. For example, the system 400 may be implemented as an integrated circuit (IC) chip or dedicated integrated circuit (ASIC). The system 400 may be implemented as a system on chip (SOC). Other manners that are currently known or developed in the future are also feasible, and the scope of the present invention is not limited in this regard.

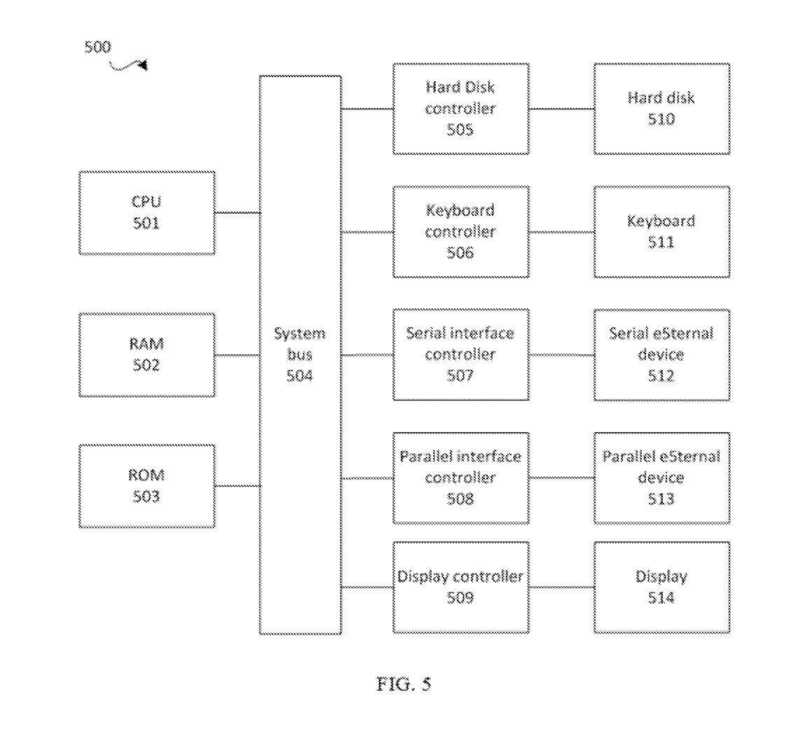

Hereinafter, referring to FIG. 5, it shows a block diagram of a computer system 500 that is applicable to implement embodiments of the present invention.

As shown, the computer system 500 includes a CPU (Central Processing Unit) 501, a RAM (Random Access Memory) 502, a ROM (Read Only Memory) 503, a system bus 504, a hard disk controller 505, a keyboard controller 506, a serial interface controller 507, a parallel interface controller 508, a monitor controller 509, a hard disk 510, a keyboard 511, a serial peripheral device 512, a parallel peripheral device 513 and a monitor 514. Among these components, connected to the system bus 504 are the CPU 501, the RAM 502, the ROM 503, the hard disk controller 505, the keyboard controller 506, the serial interface controller 507, the parallel interface controller 508 and the monitor controller 509. The hard disk 510 is coupled to the hard disk controller 505; the keyboard 511 is coupled to the keyboard controller 506; the serial peripheral device 512 is coupled to the serial interface controller 507; the parallel peripheral device 513 is coupled to the parallel interface controller 508; and the monitor 514 is coupled to the monitor controller 509. It should be understood that the structural block diagram in FIG. 5 is shown only for illustration purpose, and is not intended to limit the scope of the present invention. In some cases, some devices may be added or reduced as required.

As above mentioned, the system may be implemented through hardware, for example, chip, ASIC, SOC, etc. Such hardware may be integrated into the computer system 500. Besides, embodiments of the present invention may also be implemented in a form of a computer program product. For example, the methods of the present invention may be unexceptionally implemented through a computer program product. This computer program product may be stored in RAM 504, ROM 504, hard disk 510 and/or any suitable storage medium as illustrated in FIG. 5, or downloaded to the computer system 500 from a suitable location in the network. The computer program product may comprise a computer code portion comprising a program instruction that may be executed through a suitable processing device (for example, CPU 501 in FIG. 5). The program instruction at least may comprise an instruction for implementing the steps of the methods of the present invention.

Embodiments of the present invention can be implemented with software, hardware or the combination thereof. The hardware part can be implemented by a special logic; the software part can be stored in a memory and executed by a proper instruction execution system such as a microprocessor or a design-specific hardware. The normally skilled in the art may understand that the above method and system may be implemented with a computer-executable instruction and/or in a processor controlled code, for example, such code is provided on a bearer medium such as a magnetic disk, CD, or DVD-ROM, or a programmable memory such as a read-only memory (firmware) or a data bearer such as an optical or electronic signal bearer. The system of the present invention may be implemented by hardware circuitry of a programmable hardware device such as a very large scale integrated circuit or gate array, a semiconductor such as logical chip or transistor, or a field-programmable gate array, or a programmable logical device, or implemented by software executed by various kinds of processors, or implemented by combination of the above hardware circuitry and software.

It should be noted that although a plurality of modules or sub-modules of the system have been mentioned in the above detailed depiction, such partitioning is merely non-compulsory. In actuality, according to embodiments of the present invention, the features and functions of the above described two or more modules may be embodied in one means. In turn, the features and functions of the above described one means may be further embodied in more modules.

Besides, although operations of the present invention method are described in a particular order in the drawings, it does not require or imply that these operations must be performed according to this particular sequence, or a desired outcome can only be achieved by performing all shown operations. On the contrary, the execution sequences for the steps as depicted in the flowcharts may change. Additionally or alternatively, some steps may be omitted, a plurality of steps may be merged into one step, or a step may be divided into a plurality of steps for execution.

Although the present invention has been depicted with reference to a plurality of embodiments, it should be understood that the present invention is not limited to the disclosed embodiments. On the contrary, the present invention intends to cover various modifications and equivalent arrangements included in the spirit and scope of the appended claims. The scope of the appended claims meets the broadest explanations and covers all such modifications and equivalent structures and functions.

1-18. (canceled)

19. A computer-executable method for managing a virtual machine disk, the computer-executable method comprising:
analyzing the virtual machine disk to determining a type of provisioning of the virtual machine disk, wherein the type of provisioning relates to an amount of resources allocated to the virtual machine disk;
monitoring a usage of the virtual machine disk to determine a utilization of the virtual machine disk; and
deciding whether to modify the type of provisioning of the virtual machine disk based on the utilization of the virtual machine disk.

20. The computer-executable method of claim 19, wherein the type of provisioning of the virtual machine disk is thick provisioning

21. The computer-executable method of claim 20, wherein the monitoring comprises:
monitoring an amount of total capacity used on the virtual machine disk; and
calculating the utilization of the virtual machine disk based on the amount of total capacity used.

22. The computer-executable method of claim 19, wherein the type of provisioning of the virtual machine disk is thin provisioning

23. The computer-executable method of claim 22, wherein the monitoring comprises:
monitoring a capacity of allocated blocks in the virtual machine disk and an amount of metadata for managing the allocated blocks; and
calculating the utilization of the virtual machine disk based on the capacity of the allocated blocks and the amount of metadata.

24. The computer-executable method of claim 19, further comprising:
based on the deciding, modifying the type of provisioning of the virtual machine disk.

25. A system, comprising:
a virtual machine disk having a type of provisioning implemented thereon; and
computer-executable logic encoded in memory of one or more computers in communication with the virtual machine disk, wherein the computer-executable program logic is configured for the execution of:
analyzing the virtual machine disk to determining a type of provisioning of the virtual machine disk, wherein the type of provisioning relates to an amount of resources allocated to the virtual machine disk;
monitoring a usage of the virtual machine disk to determine a utilization of the virtual machine disk; and
deciding whether to modify the type of provisioning of the virtual machine disk based on the utilization of the virtual machine disk.

26. The system of claim 25, wherein the type of provisioning of the virtual machine disk is thick provisioning

27. The system of claim 26, wherein the monitoring comprises:
monitoring an amount of total capacity used on the virtual machine disk; and
calculating the utilization of the virtual machine disk based on the amount of total capacity used.

28. The system of claim 25, wherein the type of provisioning of the virtual machine disk is thin provisioning

29. The system of claim 28, wherein the monitoring comprises:
monitoring a capacity of allocated blocks in the virtual machine disk and an amount of metadata for managing the allocated blocks; and
calculating the utilization of the virtual machine disk based on the capacity of the allocated blocks in the virtual machine disk and the amount of metadata.

30. The computer-executable method of claim 25, wherein the computer-executable program logic is further configured for the execution of:
based on the deciding, modifying the type of provisioning of the virtual machine disk.

31. A computer program product for managing a virtual machine disk, the computer-executable method comprising:
a non-transitory computer readable medium encoded with computer-executable program code for using read signatures in replication, the code configured to enable the execution of:
analyzing the virtual machine disk to determining a type of provisioning of the virtual machine disk, wherein the type of provisioning relates to an amount of resources allocated to the virtual machine disk;
monitoring a usage of the virtual machine disk to determine a utilization of the virtual machine disk; and
deciding whether to modify the type of provisioning of the virtual machine disk based on the utilization of the virtual machine disk.

32. The computer program product of claim 31, wherein the type of provisioning of the virtual machine disk is thick provisioning

33. The computer program product of claim 32, wherein the monitoring comprises:
monitoring an amount of total capacity used on the virtual machine disk; and
calculating the utilization of the virtual machine disk based on the amount of total capacity used.

34. The computer program product of claim 31, wherein the type of provisioning of the virtual machine disk is thin provisioning

35. The computer program product of claim 34, wherein the monitoring comprises:
monitoring a capacity of allocated blocks in the virtual machine disk and an amount of metadata for managing the allocated blocks; and
calculating the utilization of the virtual machine disk based on the capacity of the allocated blocks and the amount of metadata.

36. The computer program product of claim 31, the code further configured to enable the execution of:
based on the deciding, modifying the type of provisioning of the virtual machine disk.
